(19) United States
(12) Patent Application Publication
(10) Pub. No.: US 2024/0335687 A1
(43) Pub. Date: Oct. 10, 2024

(54) Chine-Backed Flame Diverter for Rocket Systems

(71) Applicant: Relativity Space, Inc., Long Beach, CA (US)

(72) Inventors: Michael Ogrin, Mandeville, LA (US); Jason Clark, McGregor, TX (US)

(73) Assignee: Relativity Space, Inc., Long Beach, CA (US)

(21) Appl. No.: 18/631,470

(22) Filed: Apr. 10, 2024

Related U.S. Application Data
(60) Provisional application No. 63/495,241, filed on Apr. 10, 2023.

(51) Int. Cl. A62C 3/02

(52) U.S. Cl. CPC A62C 3/02

(57) ABSTRACT

Systems of chine-backed flame diverter for rocket systems are described. The chine-backed flame diverters can use a lower water supply pressure relative to the rocket exhaust plume impingement pressure. The chine-backed flame diverter systems can reduce operation costs and increase rigidity of the test stand structures.

### CROSS-REFERENCE TO RELATED APPLICATIONS

The current application claims the benefit, under 35 U.S.C. § 119(e), of U.S. Provisional Patent Application No. 63/495,241 entitled “Chine-Backed Flame Diverter for Rocket Systems” filed Apr. 10, 2023. The disclosure of U.S. Provisional Patent Application No. 63/495,241 is hereby incorporated by reference in its entirety for all purposes.

### FIELD OF THE INVENTION

The present invention generally relates to rocket plume flame diverters.

### BACKGROUND

Rocket engine testing facilities require systems to ensure safety and for controlling damage to the testing structures and equipment. During testing, hot gases (e.g., rocket plumes) and debris can cause damage to structures and create unwanted fires.

Many flame diverters have generally J-shaped radial cross-section. The exit from the flame diverter can be horizontal to provide an exit for the flames. In some designs, two J-shaped structures can be used, so that their respective exits point in opposite directions along a common axis. Flame diverters can also be referred to as flame deflectors, or flame buckets, or flame trenches.

### SUMMARY OF THE INVENTION

Systems and methods in accordance with some embodiments of the invention are directed to chine-backed flame diverter for rocket systems. In many embodiments, the chine-backed flame diverter enables using a lower water supply pressure relative to the rocket exhaust plume impingement pressure. In several embodiments, the chine-backed flame diverter allows an engine to be placed vertically closer to the diverter as compared to a flat-back diverter, when the same water system is applied. Being able to place the engine closer to the chine-backed flame diverter reduces operation cost and increases rigidity of the test stand structure. The more rigid the test stand structure, the better the thrust measurement data and the less likely unintended and difficult to detect interactions between the engine and test stand.

Some embodiments include a flame diverter configured to split and redirect an impinging rocket plume, the flame diverter comprising: a proximal end; a distal end; a first side portion extending from the proximal end to the distal end; a second side portion extending from the proximal end to the distal end, the second side portion opposite the first side portion; and a deflector surface with a generally curved profile, the deflector surface extending from the proximal end to the distal end, and extending from a first side portion bottom edge to a second side portion bottom edge, the deflector surface comprising: a V-shaped central portion, wherein, the V-shaped central portion is disposed longitudinally along a length of the deflector surface, the V-shaped central portion is centered between the first side portion and the second side portion, the V-shaped central portion has a maximum prominence at the proximal end, the V-shaped central portion gradually diminishes in prominence along the length of the deflector surface, the V-shaped central portion ends at a location along the length of the deflector surface between the proximal end and the distal end, and the V-shaped central portion comprises: a leading structure; a first leg edge with a first leg bottom end connected to the first side portion bottom edge forming a first trough; a second leg edge with a second leg bottom end connected to the second side portion bottom edge forming a second trough, and a second leg top end connected to a first leg top end, wherein the connection of the second leg top end to the first leg top end forms the leading edge; wherein the first side portion, the second side portion, and the deflector surface are comprised of one or more first diameter pipes and one or more second diameter pipes, the second diameter pipes are centrally disposed on the deflector surface, wherein the first diameter pipes and the second diameter pipes have holes configured to spray water and the first diameter pipes and the second diameter pipes are in fluid communication with one or more water supplies, and wherein the leading structure is configured to split an impinging rocket plume such that the impinging rocket plume passes over the leading structure and into the first trough and second trough.

In some embodiments, the maximum prominence is greater than or equal to a height of the first side portion and the second side portion.

In some embodiments, the maximum prominence is less than or equal to a height of the first side portion and the second side portion.

In some embodiments, the second diameter pipes have larger diameters than the first diameter pipes.

In some embodiments, the second diameter pipes and the first diameter pipes have a same diameter.

Some embodiments include a flame diverter configured to split and redirect an impinging rocket plume, the flame diverter comprising: a proximal end; a distal end; and a deflector surface extending from the proximal end to the distal end, the deflector surface comprising: a V-shaped central portion, wherein the V-shaped central portion has a maximum prominence at the proximal end, and a minimum prominence at the distal end.

In some embodiments, the deflector surface further comprises one or more pipes.

In some embodiments, the deflector surface further comprises one or more pipes in fluid communication with one or more water supply pipes.

In some embodiments, the deflector surface further comprises one or more holes, wherein the holes are configured to spray water.

In some embodiments, the deflector surface further comprises one or more pipes of a large size and one or more pipes of a smaller size, and wherein the one or more pipes of the large size are centrally disposed on the deflector surface.

In some embodiments, the deflector surface further comprises one or more pipes, and wherein an applied water pressure through the one or more pipes is higher in a center than on a first side and a second side of the deflector surface.

In some embodiments, the deflector surface further comprises a plurality of holes, and wherein the plurality of holes has a higher density in a center portion of the deflector surface than a first side and a second side of the defector surface.

In some embodiments, the deflector surface has a generally curved profile.

In some embodiments, the distal end of the deflector surface is above a horizontal line.

In some embodiments, the flame diverter further comprises a first side portion and a second side portion, wherein the first and second side portions each connect at end portions to the proximal end and the distal end, and wherein the first and second side portions each connect at bottom portions to the deflector surface.

In some embodiments, the V-shaped central portion comprises a central edge, a first leg portion, and a second leg portion, wherein the first and second leg portions meet with each other to form the central edge, the first leg portions meets with the first bottom portion of the first side portion to form a first trough, and the second leg portion meets with the second bottom portion of the second side portion to form a second trough.

In some embodiments, the maximum prominence of the V-shaped central portion is greater than or equal to a height of the first side portion.

In some embodiments, the maximum prominence of the V-shaped central portion is less than or equal to a height of the first side portion.

In some embodiments, the minimum prominence of the V-shaped central portion is zero.

Some embodiments include a flame diverter configured to split and redirect an impinging rocket plume, the flame diverter comprising: a proximal end; a distal end; and a deflector surface extending from the proximal end to the distal end, the deflector surface comprising: a leading structure, the leading structure positioned between a first trough and a second trough, the leading structure configured to split an impinging rocket plume such that the impinging rocket plume passes over the leading structure and into the first trough and second trough.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A through 1B conceptually illustrate a piped flame diverter in accordance with an embodiment.

FIGS. 2A through 2F conceptually illustrate a chine-backed flame diverter in accordance with an embodiment. FIG. 2A conceptually illustrates a front perspective view of the example chine-backed flame diverter. FIG. 2B conceptually illustrates a back perspective view of the example chine-backed flame diverter. FIG. 2C conceptually illustrates a front view of the example chine-backed flame diverter. FIG. 2D conceptually illustrates a profile view of the example chine-backed flame diverter. FIG. 2E conceptually illustrates a top view of a chine of the example chine-backed flame diverter. FIG. 2F conceptually illustrates a front view of a distal end of the example chine-backed flame diverter.

FIGS. 2G through 2J conceptually illustrate a chine-backed flame diverter with secondary structures in accordance with an embodiment. FIG. 2G conceptually illustrates a back perspective view of the chine-backed flame diverter with secondary structures. FIG. 2H conceptually illustrates a front perspective view of the chine-backed flame diverter with secondary structures. FIG. 2I conceptually illustrates a top view of the chine-backed flame diverter with secondary structures. FIG. 2J conceptually illustrates a side perspective view of the chine-backed flame diverter with secondary structures.

FIG. 2K illustrates a different configuration of a deflector surface for a chine-backed flame diverter in accordance with an embodiment.

FIGS. 3A through 3F conceptually illustrate rocket impingement temperature distribution simulations for two flame diverters in accordance with embodiments.

FIGS. 4A through 4B conceptually illustrate rocket impingement pressure distribution simulations for a chine-backed flame diverter in accordance with embodiments.

FIGS. 5A through 5H conceptually illustrate rocket impingement temperature distribution simulations for a chine-backed flame diverter with a water cannon in accordance with an embodiment.

FIG. 6 conceptually illustrates a plot depicting water cannon flow-rates versus maximum impingement pressure for a chine-backed flame diverter in accordance with an embodiment.

### DETAILED DESCRIPTION

In accordance with many embodiments of the invention flame diverters can be shaped to reduce necessary pressure. The water flow rates can affect the pressure. Water flow rates can be limited in some locations where it is desired such as launch sites and/or test facilities. Furthermore, reducing required water flow rates to operate a flame diverter can reduce infrastructure cost, reduce environmental degradation, and reduce operating costs. Chine-backed flame diverters can, in several embodiments, reduce necessary water pressure for cooling deflector surfaces (e.g., surfaces subjected to impinging rocket plumes). Chine-backed flame diverters reduce temperature and/or pressure concentrations in accordance with many embodiments of the invention.

In accordance with several embodiments of the invention the flame diverters can split and redirect an impinging rocket plume.

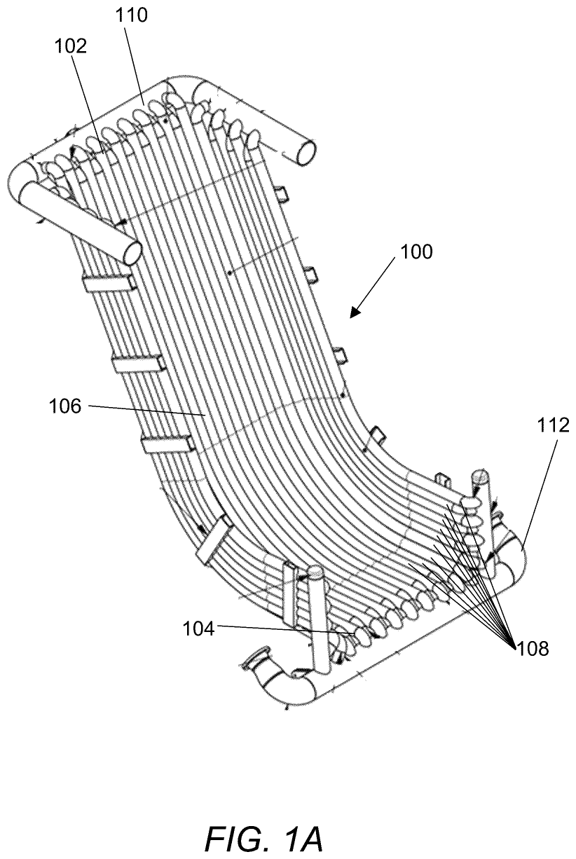

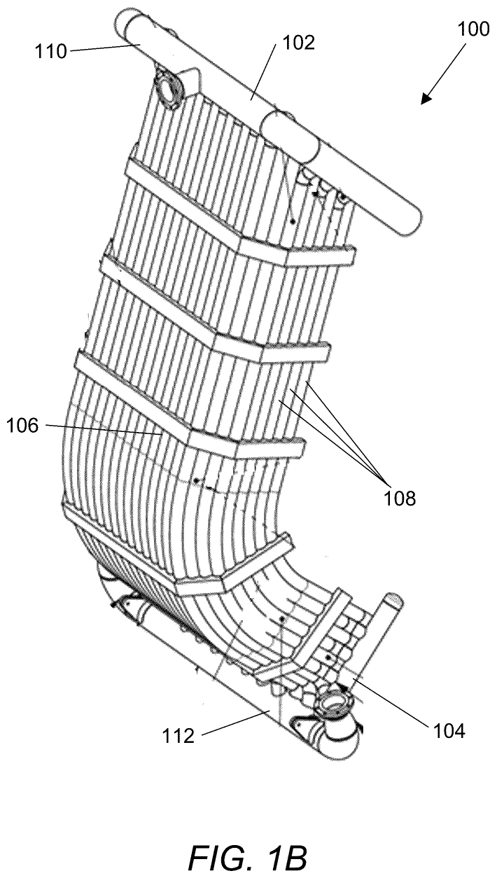

In some embodiments, flame diverters can include a series of pipes in a curved shape such as (but not limited to) a J-shape, whether a completed J-shape or a truncated J-shape. An example piped flame diverter is conceptually illustrated in FIGS. 1A-1B. A flame diverter 100 can have a proximal end 102, a distal end 104, and a deflector surface 106. The flame diverter 100 can include pipes 108, the pipes 108 can run the length of deflector surface 106. At the proximal end 102 the pipes 108 can be connected to a first water line 110. At the distal end 104 the pipes 108 can be connected to a second water line 112. In accordance with various embodiments, flame diverters can be made up of pipes forming a deflector surface. The pipes can have holes. The holes can be suitable for spraying water. The holes in the pipes can be distributed according to an expected rocket impingement on a deflector surface. The distribution of pipes can be determined based on simulations, the simulations in turn based on a flame diverter geometry.

While specific assemblies, processes and/or systems for a piped flame diverter are described above, any of a variety of assemblies, processes and/or systems can be utilized as a piped flame diverter as appropriate to the requirements of specific applications. In certain embodiments, steps and/or components may be performed and/or configured in any order, sequence, and/or configuration not limited to the order, sequence and/or configuration shown and described. In some embodiments, one or more of the above steps and/or components can be rearranged or omitted. Although the above embodiments of the invention are described in reference to a piped flame diverter, the techniques disclosed herein may be used in any type of flame diverter. The techniques disclosed herein may be used within any of the flame diverters, simulations, flame diverter components and methods as described herein.

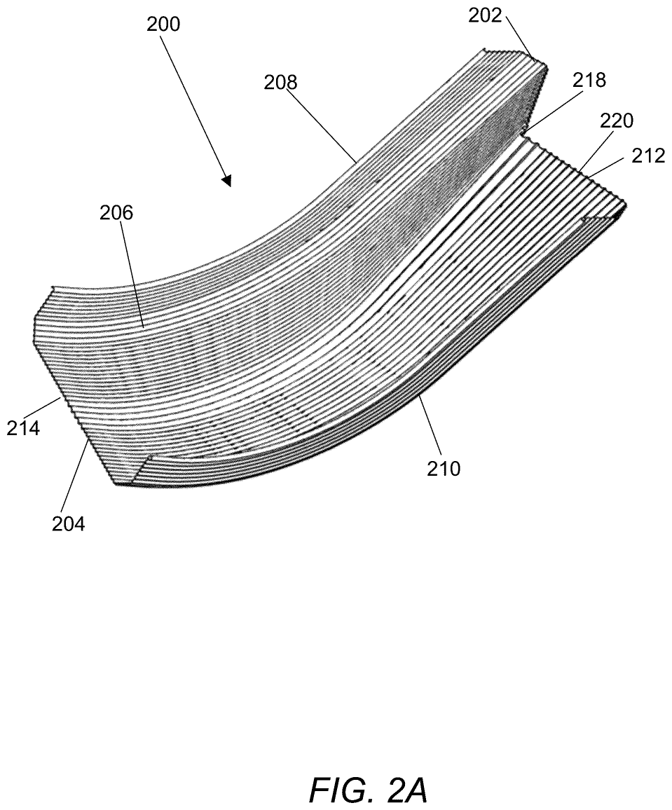

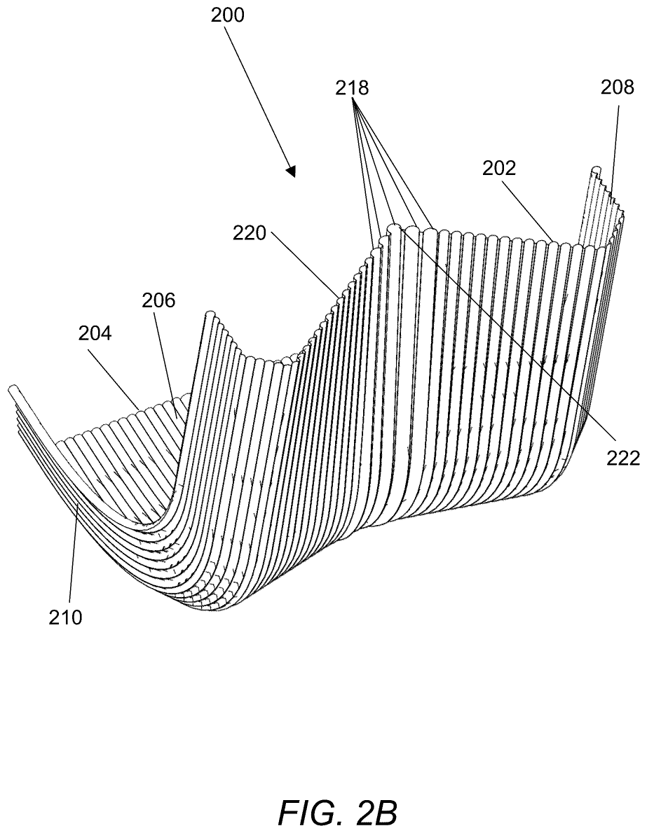

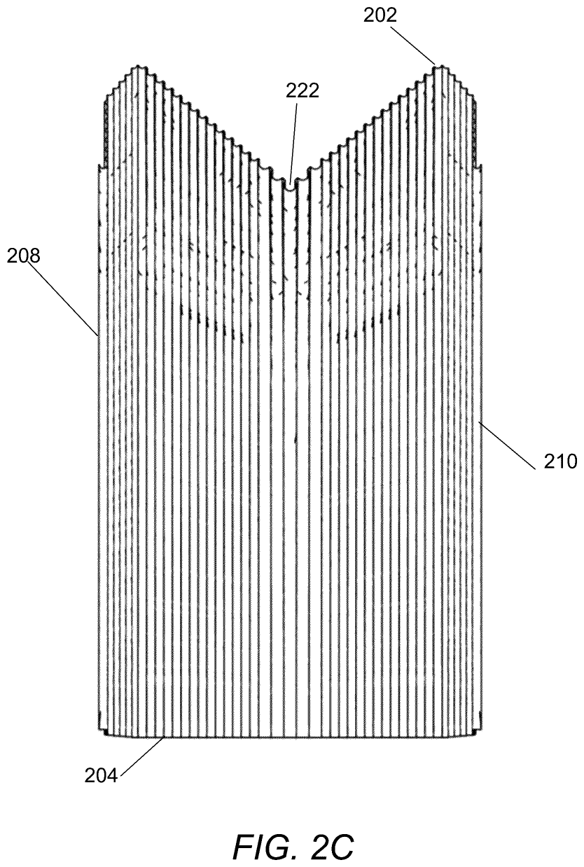

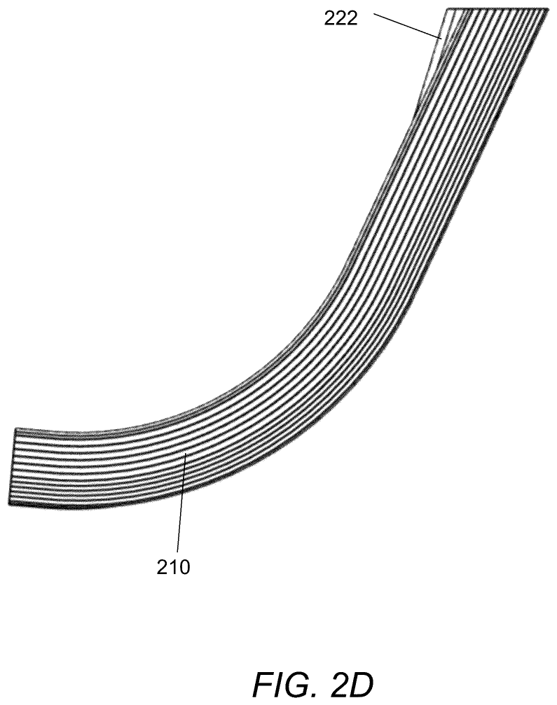

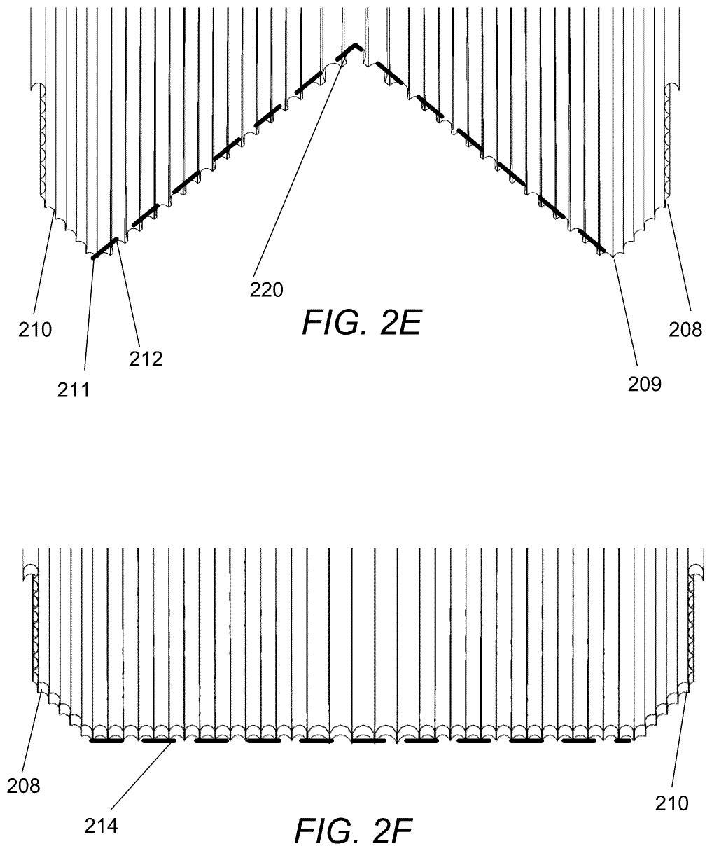

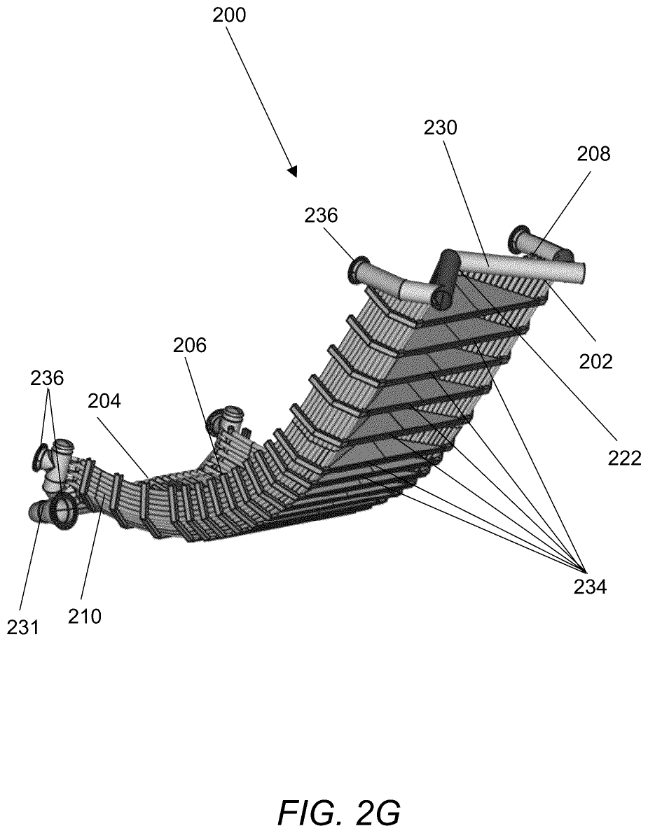

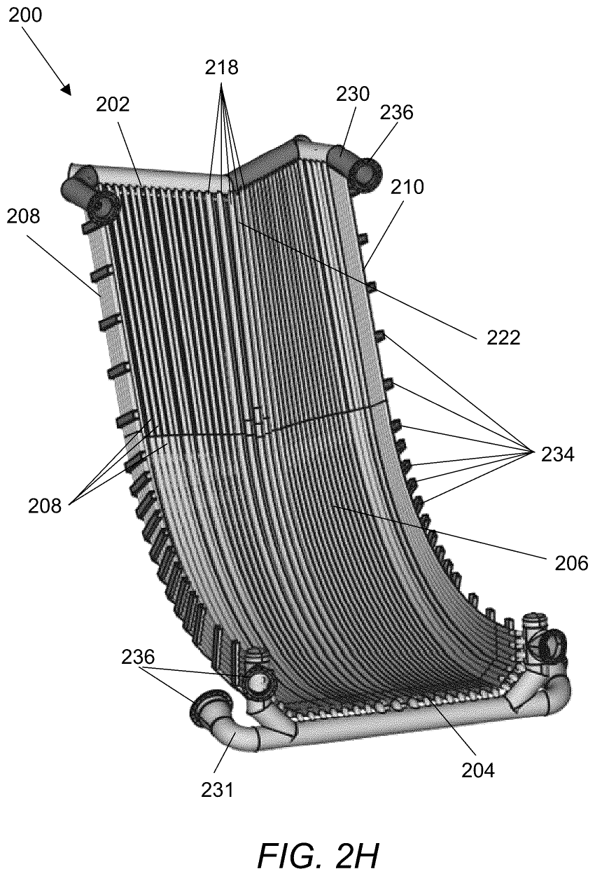

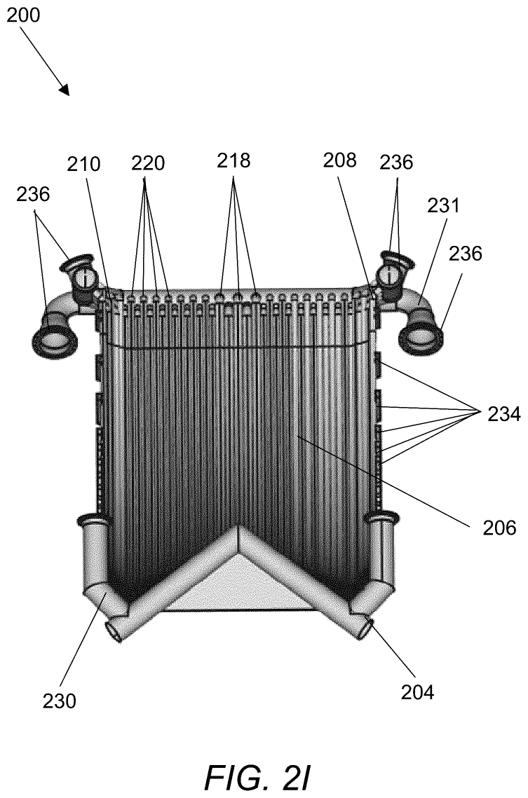

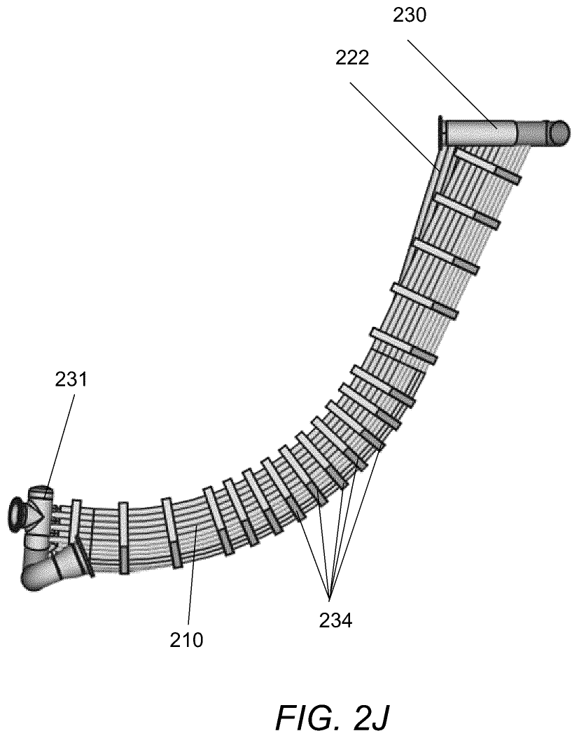

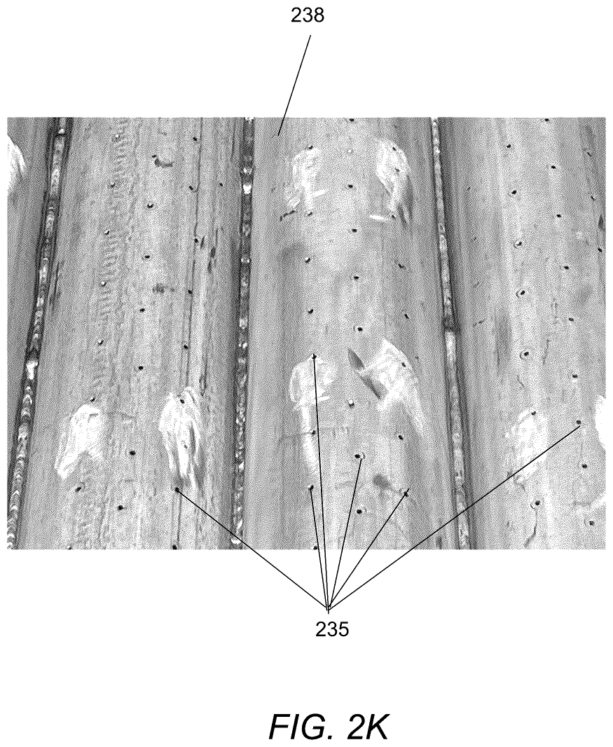

In various embodiments, chine-backed flame diverters can provide performance equivalent to straight-backed flame diverters using significantly less water pressure. A chine-backed flame diverter is conceptually illustrated in FIGS. 2A through 2F in accordance with an embodiment. FIG. 2A conceptually illustrates a front perspective view of the chine-backed flame diverter in accordance with an embodiment. FIG. 2B conceptually illustrates a back perspective view of the chine-backed flame diverter in accordance with an embodiment. FIG. 2C conceptually illustrates a front view of the chine-backed flame diverter in accordance with an embodiment. FIG. 2D conceptually illustrates a profile view of the chine-backed flame diverter in accordance with an embodiment. FIG. 2E conceptually illustrates a top view of a chine of the chine-backed flame diverter in accordance with an embodiment. FIG. 2F conceptually illustrates a front view of a distal end of the chine-backed flame diverter in accordance with an embodiment.

A chine-backed flame diverter with secondary structures is conceptually illustrated in FIGS. 2G through 2J in accordance with an embodiment. FIG. 2G conceptually illustrates a back perspective view of the chine-backed flame diverter with secondary structures. FIG. 2H conceptually illustrates a front perspective view of the chine-backed flame diverter with secondary structures. FIG. 2I conceptually illustrates a top view of the chine-backed flame diverter with secondary structures. FIG. 2J conceptually illustrates a side perspective view of the chine-backed flame diverter with secondary structures.

A flame diverter 200 can have a proximal end 202, a distal end 204, a deflector surface (or an impingement surface) 206, and side portions 208, 210. The flame diverter can have secondary structures such as (but not limited to) first water pipes 230, second water pipes 231, flanges 236, and support structures 234. The distal end 204 can be located at an end of the diverter opposite to the proximal end 202. The impingement surface 206 can span between the proximal end 202 and the distal end 204. In several embodiments, the impingement surface can be a piped surface. In many embodiments, the impingement surface can include one or more holes capable of spraying water. The deflector surface 206 has a first cross-section 212 at the proximal end 202 and a second cross-section 214 at the distal end 204. The dashed lines 212 and 214 are added to outline the cross-section shapes. The cross section of the deflector surface 206 gradually (e.g., continuously) changes along the distance between the proximal end 202 and the distal end 204. Large diameter pipes 218 are located in a central region (e.g., centrally located between side portions). Small diameter pipes 220 are used elsewhere in the flame diverter. The large diameter pipes in the central region can facilitate greater water flow for enhanced cooling along the centerline. This is beneficial since the highest heat and pressure from a rocket plume can generally, in many embodiments, be impinging along the centerline. In several embodiments, pipes can be in fluid communication with a water supply. In various embodiments, the pipes in a central region can be the same size as the pipes used elsewhere.

In various embodiments, the pipes 218 and the pipes 220 can have the same diameters and/or same sizes. Some embodiments can use same size pipes and use higher pressure water for the center section and lower pressure water further to the sides. Many embodiments implement pipes of more than two different diameters (such as three different diameters; or four different diameters; or five different diameters; or more than five different diameters) as shown in 218 and 220. As can be readily appreciated, any of a variety of sizes of pipes can be utilized to achieve a water system that has a higher water pressure in the center and lower water pressure further to the sides as appropriate to the requirements of specific applications.

In some embodiments, the pipes 218 and 220 can be connected to first water pipes 230 at the proximal end 202, and connected to second water pipes 231 at the distal end 204. The water pipes 230 and 231 can supply water supply or any fluid supply that can be used for cooling. The water pipes 230 and 231 can have flanges 236 of various sizes for connections.

In several embodiments, the deflector surface 206 can be constructed using flat plates. In some embodiments, the deflector surface 206 can be constructed using plates with grooves. In other embodiments, the deflector surface 206 can be bare portions of pipes 218, 220, and their neighboring pipes. The flat plates and/or the plates with grooves and/or the bare portions of the pipes can have a plurality of holes in them. Cooling water supplies can be added to each of a plurality of holes on the flat plates such that the deflector surface enables lowering water supply pressure relative to the rocket exhaust plume impingement pressure. As can readily be appreciated, any of a variety of deflector surface structures can be utilized as appropriate to the requirements of specific applications in accordance with various embodiments of the invention. FIG. 2K illustrates a deflector surface with a plurality of holes in accordance with an embodiment. The deflector surface can be made from a flat surface with a plurality of grooves 238. The flat surface 238 can have a chine-backed structure in accordance with various embodiments. A plurality of holes (also referred as spray holes) 235 exist in the grooves of the deflector surface 238. Cooling water can flow through the holes to cool the surface. The pattern and/or the density of the plurality of holes 235 can vary across the diverter surface. In some embodiments, there are more holes in the middle where the engine plume spends most of its time and heat flux is highest, and fewer holes farther away from the nominal impingement point. The chine-backed flame diverter enables fewer number of holes (or less hole density) compared to a flat-backed diverter. The hole pattern, density, number, and/or geometries (such as shape and/or diameter) can be selected for optimal flow rates. The angle of the chine can be determined in order to have water pressure at that point inside the diverter pipes be greater than or equal to a chine threshold pressure. The chine threshold pressure can be higher than the plume impingement/stagnation pressure at that same point. When the water pressure is lower than the chine threshold pressure, the diverter can become sensitive to individual holes plugging due to rust or other debris. When the water pressure is much lower than the chine threshold pressure, the pipe may overheat and erode around the plugged hole. When the water pressure is greater than or equal to the chine threshold pressure, the water from surrounding holes can protect the plugged one. The chine threshold pressure can be about 30 psi; or about 35 psi; or about 40 psi; or about 45 psi; or about 50 psi; or about 55 psi; or about 60 psi. For the side parts away from the chine, the angle can be a few degrees shallower. The water pressure at the side parts can be at a threshold pressure that is higher than the plume impingement pressure. The threshold pressure on the sides can be lower than the chine threshold pressure because the engine only gimbal over that far for short durations. As long as there is some water, the damage may not accumulate very fast. The threshold pressure can be about 15 psi; or about 20 psi; or about 25 psi; or about 30 psi.

Many embodiments run water through the deflector surface (through the pipes 218 and 220 or using individual water supplies on flat plates 238) for cooling. In several embodiments, any liquid such as (but not limited to) water, water solution, water solvent, water with coolant, inorganic solvent, organic solvent, can be run through the deflector surface for cooling. In some embodiments, no liquid is running in the deflector surface and the deflector surface is uncooled. In such embodiments, the chine-backed flame diverters can run for a longer duration than a flat-back design. Without cooling, the material of the diverter would rapidly heat up, but the hottest points would heat up slower with the chine style than the flat-back design. The chine-backed shape in accordance with many embodiments helps to protect or cool the primary structure and/or the design intent (intent being make exhaust go sideways rather than digging a hole).

In several embodiments, the deflector surface 206 can have a plurality of support structures 234. The support structures 234 can provide strength and support to the chine-backed flame diverter 200 during operation.

In some embodiments, the basic structure of a chine-backed flame diverter can be a metal base framework with a covering layer of refractory concrete. Refractory can be concrete that can get hot and melt and flow like glass and is commonly used for the floors of foundries. In various embodiments, the structure of the chine-backed flame diverter can be made from metal materials (such as, metal alloys, stainless steel, carbon steel) with ablative materials applied to the top. Ablative can be a phase-change material that heats up and melts and/or vaporizes to absorb and carry away the heat. Ablatives can be used on some re-entry vehicles, or as temporary protection in high intensity but short duration thermal environments, such as a flame diverter where the engine can be run for only a few seconds at a time, or for testing a launch-abort engine that pulls a capsule away from an exploding rocket on the launch pad or early in flight.

The first cross-section (outlined by the dashed line 212) can generally include a V-shape (e.g., an inverted V-shape) that is between the two side portions 208, 210. The V-shaped portion is centrally located between the side portions 208, 210. Each of side portions 208, 210 can have a bottom edge 209, 211. The two side portions 208, 210 can connect at the bottom edges 209, 211 to the deflector surface 206. The deflector surface 206 spanning the distance between the side portions 208, 210.

The second cross-section (outlined by the dashed line 214) can generally include a horizontal line shape that attaches on two sides to side portions 208, 210. In some embodiments, the exit from the chine-backed flame diverter can be horizontal or aimed slightly up (from about 0° to about 15° above horizontal) to provide an exit for the flames. The side profile views in FIG. 2D and FIG. 2J show that the exit is slightly above the horizontal line. In some embodiments, two J-shaped chine-backed flame diverters can be used, so that their respective exits point in opposite directions along a common axis.

The transition from the first cross-section 212 to the second cross-section 214 can include a chine 222. The chine 222 can be a longitudinal line of sharp change in the cross-section profile of the diverter surface 206. The chine 222 can be centrally located with respect to the side portion 208, 210. In various embodiments a chine can extend any amount (e.g., fully, partially, a percentage) from a proximal end 202 of a flame diverter to a distal end 204 of a flame diverter. The prominence of the chine can vary over the length (the length between a proximal end 202 and a distal end 204 of a flame converter). The prominence of the chine can be defined as the deviation of the chine from an equivalent straight-backed (e.g., as described elsewhere herein) flame diverter. The prominence of the chine can be defined as the distance between the center of the chine to a straight-back equivalent curve. The straight back equivalent curve being a curve identical to and offset from the curve of the side portions 208, 210. In accordance with many embodiments of the invention, flame diverters (e.g., chine-backed flame diverters) can have a generally curved profile such as (but not limited to) a J-shaped profile. As can be readily appreciated, any of a variety of curved profiles can be utilized for the flame diverters as appropriate to the requirements of specific applications.

The chine 222 can be part of the deflector surface 206. In several embodiments, a chine can be a V-shaped chine. The chine 222 is disposed longitudinally along the length of deflector surface 206. The chine 222 is centered between the first side portion 208 and the second side portion 210. In several embodiments, each side portion can have a height. The height can be measured from the bottom of a trough to the top edge of the side portion. The height of the first side portion 208 and/or the second side portion 210 can be shorter, or the same, or taller than the prominence height. The height of the first side portion 208 and/or the second side portion 210 can be dependent on how far laterally the engine is to gimbal. In accordance with several embodiments of the invention, the trough can be centered on the interface between the side portions and the chine. In many embodiments the chine has a V-shaped cross-section. The prominence (e.g., height) of the chine can vary along the length of the deflector. In some embodiments, the prominence is greatest at a proximal end 204. In accordance with many embodiments, the prominence of the chine can diminish in prominence along the length of a flame diverter. In many embodiments, the chine extends to a location between the proximal end and the distal end. In several embodiments, the chine has a minimum prominence at a distal end of a flame diverter.

In several embodiments, the geometry and/or cross-section of the chine can be described as follows. The chine can include a leading structure. The leading structure can be connected on each side to a leg edge. The leg edges can correspond to a deflector surface. At second ends, the leg edges can connect to bottom edges of side portions. Along the length of the chine, a trough can form on each side between the chine. A trough can be located between the chine and the side portions. The connection of the second leg top end to the first leg top end forms the leading edge. In many embodiments, the leading edge can be configured to split an impinging rocket plume. In some embodiments, an impinging rocket plume can pass over the leading structure and into the troughs.

FIGS. 2D and 2J conceptually illustrate a profile of a chine-backed flame diverter. A deflector surface 206 can have a generally J-shaped profile.

As can be seen in FIG. 2E, a prominence of a chine can be defined by at least a distance H between an equivalent flat-back flame diverter line 230 and a vertex 232 on a chine. The distance H can be measured, for example, at the proximal end of the flame diverter.

In several embodiments, the chine is configured to split a rocket plume and thereby reduce the pressure required for a given rocket plume. Various specific geometries of chine can be implemented for a flame diverter. The depicted example had various investigations performed on it to demonstrate its effectiveness. The chine-backed flame diverters described herein can include structural supports, water systems, spray holes, and other features common to flame diverters generally. FIGS. 2G through 2J illustrate the chine-backed flame diverters with support structures 234, the water pipes 230 and 231, and flanges 236. Spray holes can be distributed, in several embodiments, based on simulations (e.g., simulations for determining rocket impingement pressures and/or simulations for determined temperatures induced by rocket impingement), the simulations based on expected rocket impingements and flame diverter geometry.

While specific assemblies, processes and/or systems for a chine-backed flame diverter are described above, any of a variety of assemblies, processes and/or systems can be utilized as a chine-backed flame diverter as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a chine-backed flame diverter, the techniques disclosed herein may be used in any type of flame diverter. The techniques disclosed herein may be used within any of the flame diverters, simulations, flame diverter components and methods as described herein.

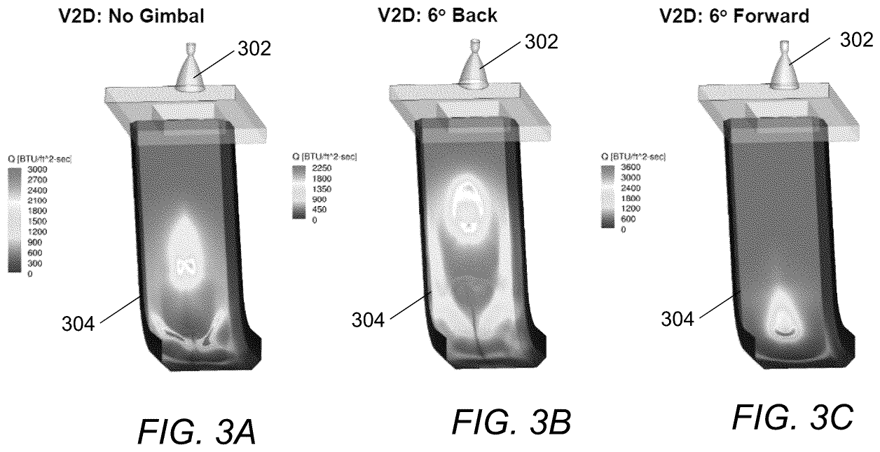

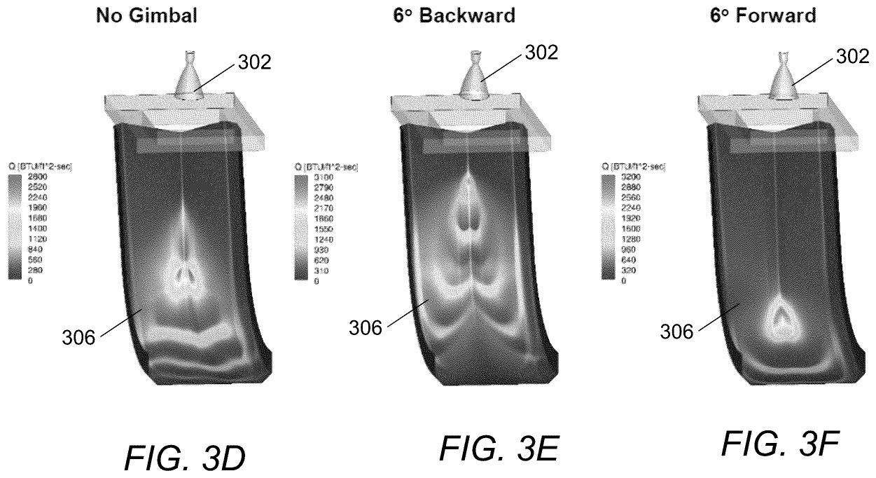

In some embodiments, flame diverters can include a series of pipes with spray holes. The distribution of the spray holes can be determined based on a temperature distribution simulation. The temperature distribution simulation can use, as an input, a geometry of a flame diverter. An example rocket impingement temperature distribution simulation for two flame diverters is conceptually illustrated in FIGS. 3A-3F. FIG. 3A depicts a simulation where a rocket 302 has no gimbal and impinges on a flat-backed flame diverter 304 producing a first temperature distribution. FIG. 3B depicts a simulation where the rocket 302 has a 6-degree back gimbal and impinges on the flat-backed flame diverter 304 producing a second temperature distribution. FIG. 3C depicts a simulation where the rocket 302 has a 6-degree forward gimbal and impinges on the flat-backed flame diverter 304 producing a third temperature distribution. FIG. 3D depicts a simulation where a rocket 302 has no gimbal and impinges on a chine-backed flame diverter 306 producing a fourth temperature distribution. FIG. 3E depicts a simulation where the rocket 302 has a 6-degree back gimbal and impinges on a chine-backed flame diverter 306 producing a fifth temperature distribution. FIG. 3F depicts a simulation where a rocket 302 has a 6-degree forward gimbal and impinges on a chine-backed flame diverter 306 producing a sixth temperature distribution. In various embodiments, impingement pressure distribution can be used instead of, or in conjunction with temperature distributions to determine suitable spray hole distributions.

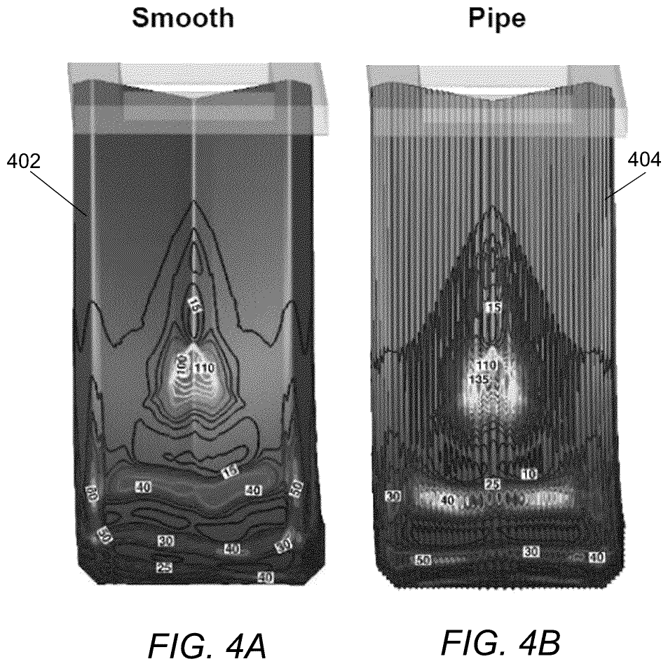

In accordance with various embodiments of the invention, a distribution of spray holes can be determined based on an impingement pressure simulation. An example rocket impingement pressure distribution simulation for a chine-backed flame diverter is conceptually illustrated in FIGS. 4A-4B. FIG. 4A depicts a pressure distribution based on a rocket (not shown) with no gimbal impinging on a smooth chine-backed flame diverter 402. FIG. 4B depicts a pressure distribution based on a rocket (not shown) with no gimbal impinging on a piped chine-backed flame diverter 404. In various embodiments, simulations can be based on smooth geometries for ease of simulation. In several embodiments, simulations can be based on more accurate (e.g., piped) geometries to improve simulation accuracy.

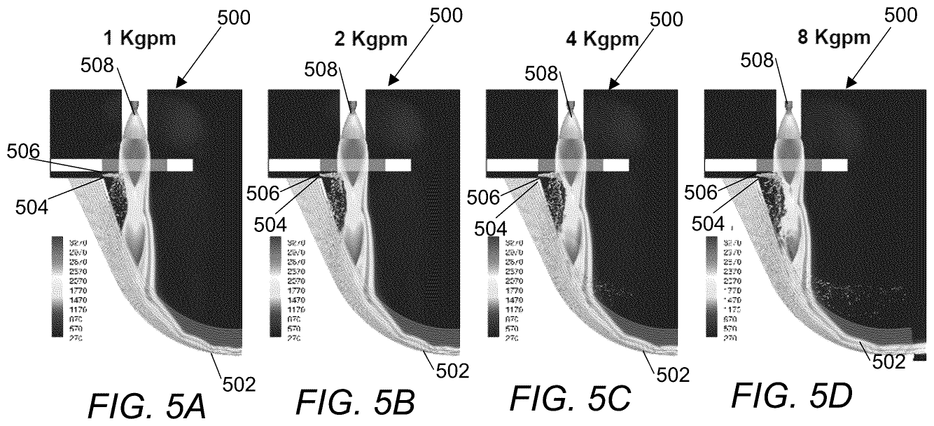

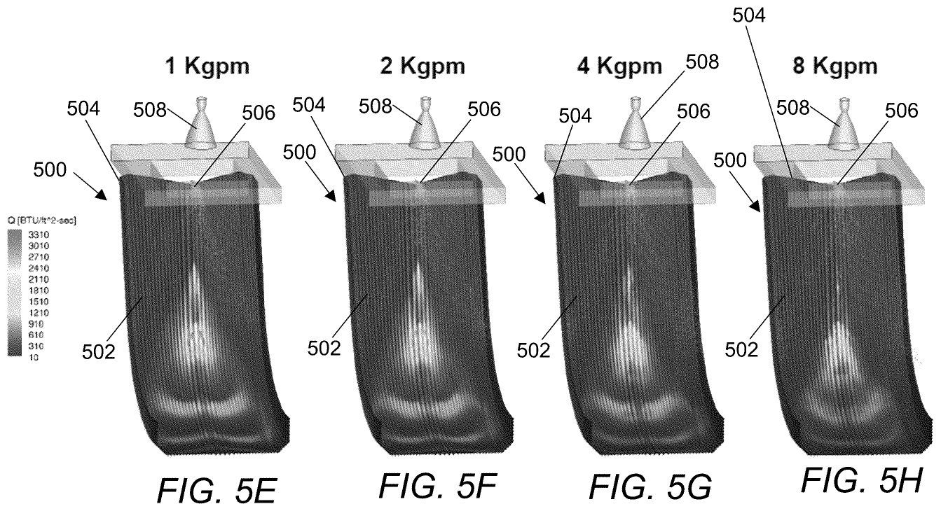

In accordance with several embodiments of the invention, a water cannon can be used in conjunction with a flame diverter. The water cannon can be used to push the rocket plume away from the flame diverter. An example temperature distribution simulation for a chine-backed flame diverter with a water cannon is conceptually illustrated in FIGS. 5A-5H. A chine-backed flame diverter 500 can include a deflector surface 502 with a proximal end 504. A water cannon 506 can be mounted at a proximal end 504.

FIG. 5A depicts a temperature distribution based on a rocket 508 with no gimbal impinging on a chine-backed flame diverter 500 with the inclusion of the water cannon 506 spraying water at a first rate (e.g., 1 kilogallon per minute) into the rocket plume. FIG. 5B depicts a temperature distribution based on a rocket 508 with no gimbal impinging on the chine-backed flame diverter 500 with the inclusion of the water cannon 506 spraying water at a second rate (e.g., 2 kilogallons per minute) into the rocket plume. FIG. 5C depicts a temperature distribution based on the rocket 508 with no gimbal impinging on the chine-backed flame diverter 500 with the inclusion of the water cannon 506 spraying water at a third rate (e.g., 4 kilogallons per minute) into the rocket plume. FIG. 5D depicts a temperature distribution based on the rocket 508 with no gimbal impinging on the chine-backed flame diverter 500 with the inclusion of the water cannon 506 spraying water at a fourth rate (e.g., 8 kilogallons per minute) into the rocket plume.

FIG. 5E depicts a second view of a temperature distribution based on a rocket 508 with no gimbal impinging on a chine-backed flame diverter 500 with the inclusion of the water cannon 506 spraying water at a first rate (e.g., 1 kilogallon per minute) into the rocket plume. FIG. 5F depicts a second view of a temperature distribution based on a rocket 508 with no gimbal impinging on the chine-backed flame diverter 500 with the inclusion of the water cannon 506 spraying water at a second rate (e.g., 2 kilogallons per minute) into the rocket plume. FIG. 5G depicts a second view of a temperature distribution based on the rocket 508 with no gimbal impinging on the chine-backed flame diverter 500 with the inclusion of the water cannon 506 spraying water at a third rate (e.g., 4 kilogallons per minute) into the rocket plume. FIG. 5H depicts a second view of a temperature distribution based on the rocket 508 with no gimbal impinging on the chine-backed flame diverter 500 with the inclusion of the water cannon 506 spraying water at a fourth rate (e.g., 8 kilogallons per minute) into the rocket plume.

In various embodiments flame diverters can include water cannons. Water cannons can be positioned at the proximal end of flame diverters. Water cannons can be configured to use flow rates of 1 kilogallon per minute (Kgpm), 2 Kgpm, 4 Kgpm, 8 Kgpm, and/or another flow rate.

While specific assemblies, processes and/or systems for a rocket impingement temperature/pressure distribution simulation for flame diverters are described above, any of a variety of assemblies, processes and/or systems can be utilized as a rocket impingement temperature/pressure distribution simulation for flame diverters as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a rocket impingement temperature/pressure distribution simulation for flame diverters, the techniques disclosed herein may be used in any type of flame diverter. The techniques disclosed herein may be used within any of the flame diverters, simulations, flame diverter components and methods as described herein.

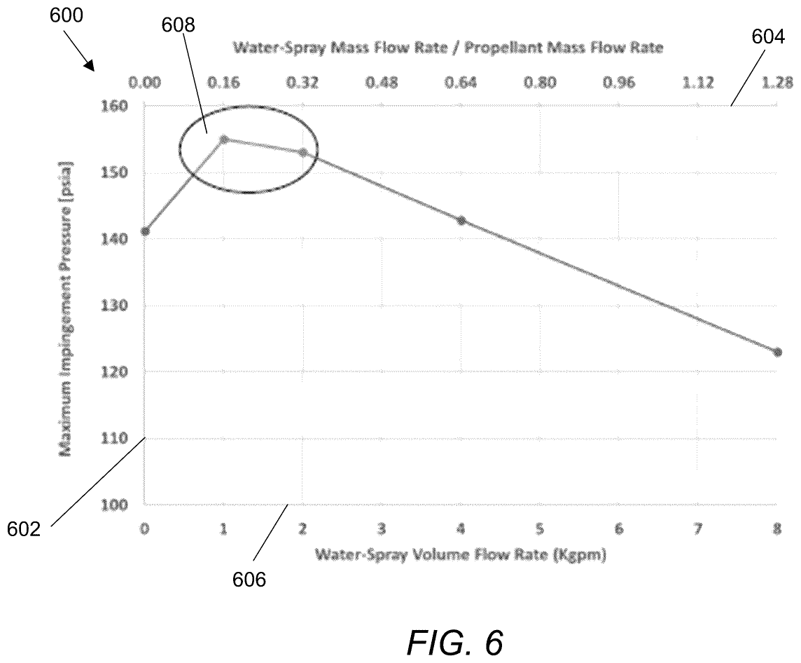

In some embodiments, water cannons can be configured to use flow rates measured as a ratio of water-spray mass flow rate/propellant mass flow rate. A plot depicting water cannon flow-rates versus maximum impingement pressure for a chine-backed flame diverter is illustrated in FIG. 6. The plot 600 includes a first axis 602 that corresponds to maximum impingement pressure, and a second axis 604 and a third axis 606. The second axis 604 and the third axis 606 can be perpendicular to the first axis 602. The second axis 604 can correspond to a ratio of cannon water spray mass flow rate/propellant mass flow rate. The third axis 606 can correspond to a cannon water splay volume flow rate. As can be seen in the FIG. 6, low cannon water spray volume flow rates can correspond to increased maximum impingement pressure. A region 608 can correspond to a region wherein water cannon spray volume flow rates correspond with increased maximum impingement pressure. In several embodiments, water cannon flow rates corresponding to a ratio of water-spray cannon mass flow rate/propellant mass flow rate can be at least 0.35, 0.48, 0.64 or another ratio to reduce the maximum impingement pressure on a chine-backed flame diverter.

A perspective view of an example chine-backed piped flame diverter is conceptually illustrated in FIG. 7. A flame diverter 700 can have a proximal end 702, a distal end 704, and a deflector surface 706. The flame diverter 700 can include pipes 708, the pipes 708 can run the length of deflector surface 706. At the proximal end 702 the pipes 708 can be connected to a first water line 710. At the distal end 704 the pipes 708 can be connected to a second water line 712. The flame diverter 700 can include a chine back 714. The pipers 708 can include large diameter pipes that are arranged about a central plane of the flame diverter and/or small diameter pipes arranged further from the central plane. The central plane can be aligned with a vertex 716 of the chine 714. The central plan can bisect the flame diverter 700.

### Doctrine of Equivalents

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

In this disclosure, the words “including,” “such as,” “e.g.,” and related terms are not closed-ended and should be interpreted as having the explanatory language “but not limited to.” Likewise, the term “include” is not closed-ended and should be interpreted such that what proceeds is not limiting on the term that precedes.

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to +0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A flame diverter configured to split and redirect an impinging rocket plume, the flame diverter comprising:
a proximal end;
a distal end;
a first side portion extending from the proximal end to the distal end;
a second side portion extending from the proximal end to the distal end, the second side portion opposite the first side portion; and
a deflector surface with a generally curved profile, the deflector surface extending from the proximal end to the distal end, and extending from a first side portion bottom edge to a second side portion bottom edge, the deflector surface comprising:
a V-shaped central portion, wherein,
the V-shaped central portion is disposed longitudinally along a length of the deflector surface,
the V-shaped central portion is centered between the first side portion and the second side portion,
the V-shaped central portion has a maximum prominence at the proximal end,
the V-shaped central portion gradually diminishes in prominence along the length of the deflector surface,
the V-shaped central portion ends at a location along the length of the deflector surface between the proximal end and the distal end, and
the V-shaped central portion comprises:
a leading structure;
a first leg edge with a first leg bottom end connected to the first side portion bottom edge forming a first trough;
a second leg edge with a second leg bottom end connected to the second side portion bottom edge forming a second trough, and a second leg top end connected to a first leg top end, wherein the connection of the second leg top end to the first leg top end forms the leading edge;
wherein the first side portion, the second side portion, and the deflector surface are comprised of one or more first diameter pipes and one or more second diameter pipes, the second diameter pipes are centrally disposed on the deflector surface,
wherein the first diameter pipes and the second diameter pipes have holes configured to spray water and the first diameter pipes and the second diameter pipes are in fluid communication with one or more water supplies, and
wherein the leading structure is configured to split an impinging rocket plume such that the impinging rocket plume passes over the leading structure and into the first trough and second trough.

2. The flame diverter of claim 1, wherein the maximum prominence is greater than or equal to a height of the first side portion and the second side portion.

3. The flame diverter of claim 1, wherein the maximum prominence is less than or equal to a height of the first side portion and the second side portion.

4. The flame diverter of claim 1, wherein the second diameter pipes have larger diameters than the first diameter pipes.

5. The flame diverter of claim 1, wherein the second diameter pipes and the first diameter pipes have a same diameter.

6. A flame diverter configured to split and redirect an impinging rocket plume, the flame diverter comprising:
a proximal end;
a distal end; and
a deflector surface extending from the proximal end to the distal end, the deflector surface comprising:
a V-shaped central portion, wherein the V-shaped central portion has a maximum prominence at the proximal end, and a minimum prominence at the distal end.

7. The flame diverter of claim 6, wherein the deflector surface further comprises one or more pipes.

8. The flame diverter of claim 6, wherein the deflector surface further comprises one or more pipes in fluid communication with one or more water supply pipes.

9. The flame diverter of claim 6, wherein the deflector surface further comprises one or more holes, wherein the holes are configured to spray water.

10. The flame diverter of claim 6, wherein the deflector surface further comprises one or more pipes of a large size and one or more pipes of a smaller size, and wherein the one or more pipes of the large size are centrally disposed on the deflector surface.

11. The flame diverter of claim 6, wherein the deflector surface further comprises one or more pipes, and wherein an applied water pressure through the one or more pipes is higher in a center than on a first side and a second side of the deflector surface.

12. The flame diverter of claim 6, wherein the deflector surface further comprises a plurality of holes, and wherein the plurality of holes has a higher density in a center portion of the deflector surface than a first side and a second side of the defector surface.

13. The flame diverter of claim 6, wherein the deflector surface has a generally curved profile.

14. The flame diverter of claim 6, wherein the distal end of the deflector surface is above a horizontal line.

15. The flame diverter of claim 6, wherein the flame diverter further comprises a first side portion and a second side portion, wherein the first and second side portions each connect at end portions to the proximal end and the distal end, and wherein the first and second side portions each connect at bottom portions to the deflector surface.

16. The flame diverter of claim 15, wherein the V-shaped central portion comprises a central edge, a first leg portion, and a second leg portion, wherein the first and second leg portions meet with each other to form the central edge, the first leg portions meets with the first bottom portion of the first side portion to form a first trough, and the second leg portion meets with the second bottom portion of the second side portion to form a second trough.

17. The flame diverter of claim 15, wherein the maximum prominence of the V-shaped central portion is greater than or equal to a height of the first side portion.

18. The flame diverter of claim 15, wherein the maximum prominence of the V-shaped central portion is less than or equal to a height of the first side portion.

19. The flame diverter of claim 6, wherein the minimum prominence of the V-shaped central portion is zero.

20. A flame diverter configured to split and redirect an impinging rocket plume, the flame diverter comprising:
a proximal end;
a distal end; and
a deflector surface extending from the proximal end to the distal end, the deflector surface comprising:
a leading structure, the leading structure positioned between a first trough and a second trough, the leading structure configured to split an impinging rocket plume such that the impinging rocket plume passes over the leading structure and into the first trough and second trough.
